(19) United States
(12) Patent Application Publication
(10) Pub. No.: US 2023/0237354 A1
(43) Pub. Date: Jul. 27, 2023

(54) TIME-SPECIFIC AREA CROWD-SIZE ESTIMATION METHOD, TIME-SPECIFIC AREA CROWD-SIZE ESTIMATION APPARATUS AND PROGRAM

(71) Applicant: NIPPON TELEGRAPH AND TELEPHONE CORPORATION, Tokyo (JP)

(72) Inventors: Yasunori AKAGI, Tokyo (JP); Yusuke TANAKA, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 18/008,923

(22) PCT Filed: Jun. 15, 2020
(86) PCT No.: PCT/JP2020/023481

§ 371 Date: Dec. 7, 2022

(51) Int. Cl. G06N 7/01; G06N 20/00

(52) U.S. Cl. CPC G06N 7/01; G06N 20/00

(57) ABSTRACT

Disclosed is a time-specific area population estimation method executed by a computer. The method includes estimating a time-specific interareal movement probability, based on observed time-specific population in an area and a set of candidate areas for a movement from the area in a unit time; and estimating a population in the area at a time at which no observation is performed by using a cost function learned in the estimating of the time-specific interareal movement probability.

### TECHNICAL FIELD

The present invention relates to a time-specific area population estimation method, a time-specific area population estimation apparatus, and a program.

### BACKGROUND ART

Location information on a person obtained from a global positioning system (GPS) or the like may be provided as time-specific area population data from which an individual cannot be tracked due to privacy considerations. Here, the time-specific area population data is information on the number of people per area on a per time step basis. The area is obtained, for example, by dividing a geographic space into grid shapes. Such data is observed per constant time interval, but there is a need to estimate a population at a time at which no observation is performed.

In the related art, population prediction technology based on supervised learning (NPL 1), a semi-supervised estimation using Wasserstein Propagation (NPL 2), and the like has been proposed.

### CITATION LIST

### Non-Patent Literature

NPL 1: J. Zhang at al. Deep Spatio-Temporal Residual Networks for Citywide Crowd Flows Prediction. In Proceedings of the 31st AAAI Conference on Artificial Intelligence. 2017
NPL 2: J. Solomon et al. Wasserstein Propagation for Semi-Supervised Learning. In Proceedings of the 31st International Conference on Machine Learning. 2014

### SUMMARY OF THE INVENTION

### Technical Problem

However, there are two problems with the related art.

(1) In a scheme based on supervised learning, various types of external information are required as feature quantities for estimation, and a large amount of learning data is required for performing learning of a model.

(2) In an existing semi-supervised estimation scheme, it is necessary to manually determine a cost function for measuring a distance between distributions in advance. It is difficult to determine this well when data is limited, and when an appropriate cost is not selected, a solution greatly different from the reality is likely to be output.

The present invention has been made in view of the above point, and an object is to make it possible to efficiently estimate a population at a time at which no observation is performed.

### Means for Solving the Problem

Thus, in order to solve the above problems, a computer executes a movement probability estimation procedure for estimating a time-specific interareal movement probability, based on observed time-specific population in an area and a set of candidate areas for a movement from the area in a unit time, and a time-specific area population estimation procedure for estimating a population in the area at a time at which no observation is performed, wherein the population is estimated by using a cost function learned in the estimation of the movement probability.

### Advantageous Effects of the Invention

A population can be efficiently estimated at a time at which no observation is performed.

### BRIEF DESCRIPTION OF DRAWINGS

FIG. 1 is a diagram illustrating a hardware configuration example of a time-specific area population estimation apparatus 10 according to an embodiment of the present invention.

FIG. 2 is a diagram illustrating a functional configuration example of the time-specific area population estimation apparatus 10 according to the embodiment of the present invention.

FIG. 3 is a table showing a configuration example of an observation-time-specific area population storage unit 121.

FIG. 4 is a table showing a configuration example of an estimated movement probability storage unit 122.

FIG. 5 is a table showing a configuration example of an estimation-time-specific area population storage unit 123.

### DESCRIPTION OF EMBODIMENTS

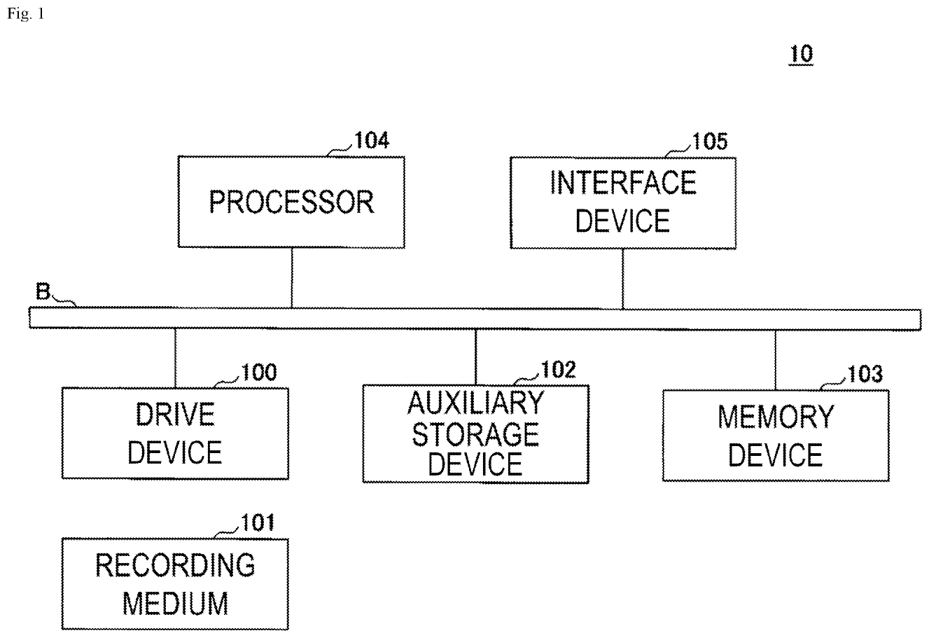

Hereinafter, embodiments of the present invention will be described based on the drawings. FIG. 1 is a diagram illustrating a hardware configuration example of a time-specific area population estimation apparatus 10 according to an embodiment of the present invention. The time-specific area population estimation apparatus 10 in FIG. 1 includes a drive device 100, an auxiliary storage device 102, a memory device 103, a processor 104, an interface device 105, and the like, which are connected to each other by a bus B.

A program that implements processing in the time-specific area population estimation apparatus 10 is provided by a recording medium 101 such as a CD-ROM. When the recording medium 101 storing the program is set in the drive device 100, the program is installed in the auxiliary storage device 102 from the recording medium 101 via the drive device 100. However, the program need not be installed from the recording medium 101, and the program may be downloaded from another computer via a network. The auxiliary storage device 102 stores the installed program and also stores necessary files, data, and the like.

The memory device 103 reads and stores the program from the auxiliary storage device 102 in response to receiving an instruction to activate the program. The processor 104 is a CPU or a graphics processing unit (GPU), or a CPU and a GPU, and executes a function related to the time-specific area population estimation apparatus 10 according to a program stored in the memory device 103. The interface device 105 is used as an interface for connection to a network.

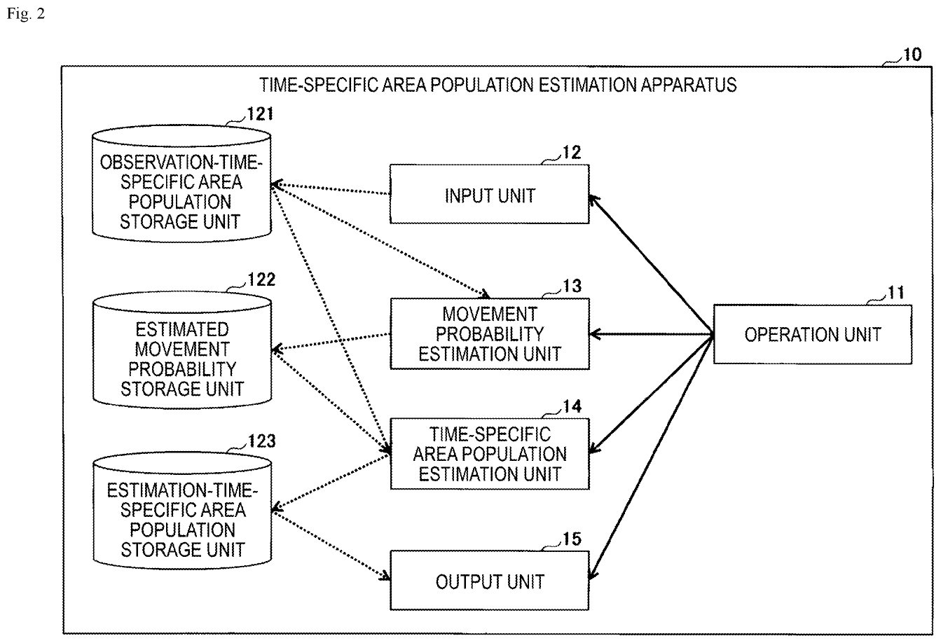

FIG. 2 is a diagram illustrating a functional configuration example of the time-specific area population estimation apparatus 10 in the embodiment of the present invention. In FIG. 2, the time-specific area population estimation apparatus 10 includes an operation unit 11, an input unit 12, a movement probability estimation unit 13, a time-specific area population estimation unit 14, an output unit 15, and the like in order to estimate the number of people moving between areas per time step from the observed time-specific area population data. Each of these units is implemented by causing the processor 104 to execute a process by using one or more programs installed in the time-specific area population estimation apparatus 10. The time-specific area population estimation apparatus 10 also uses storage units such as an observation-time-specific area population storage unit 121, an estimated movement probability storage unit 122, and an estimation-time-specific area population storage unit 123. Each of these storage units can be implemented by using, for example, the auxiliary storage device 102 or a storage apparatus that can be connected to the time-specific area population estimation apparatus 10 via a network. In FIG. 2, a solid arrow indicates a calling relationship between functional units, and a broken arrow indicates a flow of data.

The operation unit 11 is an interface for performing an operation from the outside, and the operation unit 11 enables operations, such as storage and correction of the input data in the observation-time-specific area population storage unit 121 through operating the input unit, start of the movement probability estimation according to an instruction directed to the movement probability estimation unit 13, start of the estimation of the area population at a time at which no observation is performed according to an instruction directed to the time-specific area population estimation unit 14, and output of an estimation result according to an instruction directed to the output unit 15.

The input unit 12 stores the observed time-specific area population data in the observation-time-specific area population storage unit 121 and corrects the data.

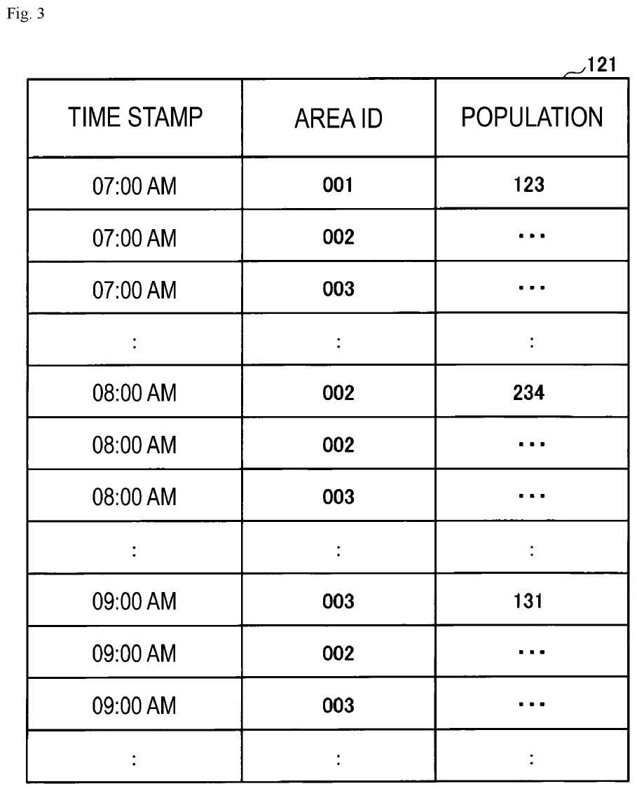

FIG. 3 is a table showing a configuration example of the observation-time-specific area population storage unit 121. As illustrated in FIG. 3, for respective records (hereinafter referred to as “input population data”) of the observation-time-specific area population storage unit 121, a time stamp (time), an area ID, population information, and the like are stored. The area ID is identification information for each area. The area is obtained, for example, by dividing a geographic space into grid shapes. The population information is a population observed at a time related to the time stamp in the area related to the area ID.

The movement probability estimation unit 13 reads a time-specific area population data group from the observation-time-specific area population storage unit 121, and the movement probability estimation unit 13 estimates a time-specific interareal movement probability based on the time-specific area population data group while using the collective flow diffusion model (CFDM) (A. Kumar, D. Sheldon, B. Srivastava. Diffusion Over Networks: Models and Inference. In Proceedings of the 29th Conference on Uncertainty in Artificial Intelligence 2013.).

Symbols are defined as follows.
For a natural number k, [k]:={1, . . . , k}
V: A set of all areas
T: A maximum value of a time step (that is, the time step is t=1, . . . , T)
G=(V, E): An undirected graph representing a movable adjacency relationship between areas in a period from time t to time t+1 (during one time step (unit time))
Γᵢ: A set of movement candidate areas in a period from time t to time t+1 from an area i (can be identified from G)
Population in the area i at time t: Nₜᵢ(tϵ[T], iϵV)
The number of people who have moved from the area i to an area j from time t to time t+1: Mₜᵢⱼ(tϵ[T−1], jϵV)
   It is assumed that the time-specific area population data Nₜᵢ(tϵ[T], iϵV) observed at a time in an area on time basis as illustrated in FIG. 3 is given as an input. When the probability of movement from the area i to the area j is θᵢⱼ, it is assumed that the number of people moving from the area i at time t, Mₜᵢ={Mₜᵢⱼ|jϵV}, is generated at a probability of

$$\begin{matrix}[ Math . 1 ] & \\ P ( {M}_{t i} \vert {N}_{ti} , {θ}_{i} ) = \frac{{N}_{t i} !}{{\prod }_{j ∈ {Γ}_{i}} {M}_{tij} !} {\prod }_{j ∈ {Γ}_{i}} {θ}_{ij}^{{M}_{tij}} & ( 1 )\end{matrix}$$

using a movement probability from i, θᵢ={θᵢⱼ|ϵΓᵢ}. Thus, when N={Nₜᵢ|tϵ[T], iϵV}, and θ={θᵢ|iϵV} are given, a posterior probability M={Mₜᵢ|tϵ[T−1], iϵV} becomes

$$\begin{matrix}[ Math . 2 ] & \\ P ( M \vert N , θ ) ∝ {\prod }_{t ∈ [ T - 1 ]} {\prod }_{i ∈ V} ( \frac{{N}_{ti} !}{{\prod }_{j ∈ {Γ}_{i}} {M}_{tij} !} {\prod }_{j ∈ {Γ}_{i}} {θ}_{ij}^{{M}_{tij}} ) & ( 2 )\end{matrix}$$

Further, a constraint indicating a number-of-people conservation law

$$\begin{matrix}[ Math . 3 ] & \\ {N}_{t i} = {\sum }_{j ∈ {Γ}_{i}} {M}_{tij} ( t ∈ [ T - 1 ] , i ∈ V ) & ( 3 )\end{matrix}$$

$${N}_{t + 1 , i} = {\sum }_{j ∈ {Γ}_{i}} {M}_{tji} ( t ∈ [ T - 1 ] , i ∈ V ) \qquad ( 4 )$$

is satisfied.

Further, it is assumed that a movement probability θ is parameterized by a certain parameter β.

The movement probability estimation unit 13 estimates time- and area-specific movement probabilities based on CFDM (Relationships (2) to (4)), and outputs the estimated movement probability to the estimated movement probability storage unit 122.

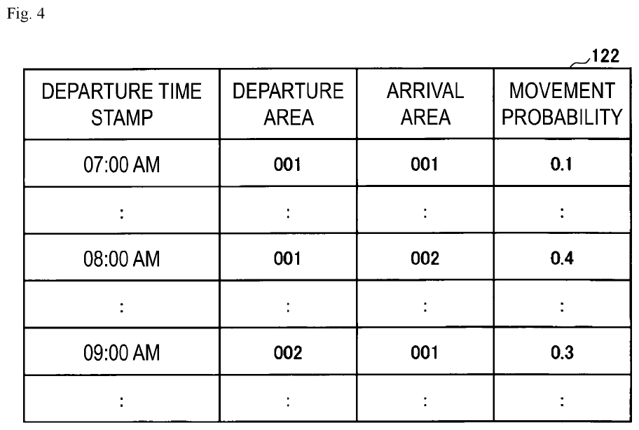

FIG. 4 is a table showing the configuration example of the estimated movement probability storage unit 122. As illustrated in FIG. 4, the estimated movement probability storage unit 122 stores a movement probability estimated for each of combinations of a departure area and an arrival area on a per departure time stamp (each departure time) basis.

An example of a specific processing procedure that is executed by the movement probability estimation unit 13 is as follows.

The estimation is performed by minimizing a negative logarithmic posterior probability

$$\begin{matrix}[ Math . 4 ] & \\ \begin{matrix}- log P ( M \vert N , θ ) = - {\sum }_{t ∈ [ T - 1 ]} {\sum }_{i ∈ V} ( log {N}_{t i} ! - {\sum }_{j ∈ {Γ}_{i}} log {M}_{tij} ! + {\sum }_{j ∈ {Γ}_{i}} {M}_{tij} log {θ}_{ij} ) \\ = {\sum }_{t ∈ [ T - 1 ]} {\sum }_{i ∈ V} {\sum }_{j ∈ {Γ}_{i}} ( log {M}_{tij} - {M}_{tij} log {θ}_{ij} ) + const .\end{matrix} & ( 5 )\end{matrix}$$

under constraints (3) and (4). That is, an optimization problem to be solved is

$$\begin{matrix}[ Math . 5 ] & \\ \begin{matrix}{minimize}_{M , θ} & {\sum }_{t ∈ [ T - 1 ]} {\sum }_{i ∈ V} {\sum }_{j ∈ {Γ}_{i}} ( log {M}_{tij} ! - {M}_{tij} log {θ}_{ij} ) ,\end{matrix} & ( 6 a )\end{matrix}$$

$$\begin{matrix}subject to & {N}_{t i} = {\sum }_{j ∈ {Γ}_{i}} {M}_{tij} ( t = 0 , 1 , … , T - 2 ) ,\end{matrix} \qquad ( 6 b )$$

$${N}_{t + 1 , i} = {\sum }_{j ∈ {Γ}_{i}} {M}_{tji} ( t ∈ [ T - 1 ] , i ∈ V ) \qquad ( 6 c )$$

$${\sum }_{j ∈ {Γ}_{i}} {θ}_{i j} = 1 ( t ∈ [ T - 1 ] , i ∈ V ) \qquad ( 6 d )$$

$$0 \leq {θ}_{ij} \leq 1 ( i , j ∈ V ) \qquad ( 6 e )$$

$${M}_{tij} ∈ {ℤ}_{\geq 0} \qquad ( 6 f )$$

$$\begin{matrix}[ Math . 6 ] & \\ {ℤ}_{\geq 0} & \end{matrix}$$

is a set of all integers equal to or greater than 0. Minimization of a likelihood function L(M, θ) is performed by alternating minimization of M and θ.

In order to update M, the optimization problem

$$\begin{matrix}[ Math . 7 ] & \\ \begin{matrix}{min}_{{M}_{t}} . & {\sum }_{i ∈ V} {\sum }_{j ∈ {Γ}_{i}} ( log {M}_{tij} ! - {M}_{tij} log {θ}_{ij} ) , \\ s . t . & {N}_{ti} = {\sum }_{j ∈ {Γ}_{i}} {M}_{tij} ( i ∈ V ) , \\ & {N}_{t + 1 , i} = {\sum }_{j ∈ {Γ}_{i}} {M}_{tji} ( i ∈ V ) , \\ & {M}_{tij} ∈ {ℤ}_{\geq 0} ( i ∈ V , j ∈ {Γ}_{i} ) .\end{matrix} & ( 7 )\end{matrix}$$

may be solved independently for tϵ[T−2].

First, the movement probability estimation unit 13 performs preprocessing so that Σ_{iϵV}Nₜ, i=Σ_{iϵV}N_{t+1, i} is satisfied. In order to achieve this, a virtual area v is added, and N_{t, v}=Σ_{iϵV}N_{t+1, i}−Σ_{iϵV}N_{t, i} and N_{t+1, v}=0 may be set when Σ_{iϵV}N_{t, i}<Σ_{iϵV}N_{t+1, i} and, N_{t, v}=0 and N_{t+1, v}=Σ_{iϵV}N_{t, i}−Σ_{iϵV}N_{t+1, i} may be set when Σ_{iϵV}N_{t, i}>Σ_{iϵV}N_{t, i}. After performing this processing, the movement probability estimation unit 13 sets F=Σ_{iϵV}N_{t, i}=Σ_{iϵV}N_{t+1,i}.

Here, Stirling's approximation log Mₜᵢⱼ!≅Mₜᵢⱼ log Mₜᵢⱼ−Mₜᵢⱼ is applied to an objective function of problem (7) to continuously relax Mₜᵢⱼ such that an optimization problem

$$\begin{matrix}[ Math . 8 ] & \\ \begin{matrix}{min}_{{M}_{t}} . & {\sum }_{i ∈ V} {\sum }_{j ∈ {Γ}_{i}} ( {M}_{tij} log {M}_{ij} - {M}_{tij} log {θ}_{ij} ) , \\ s . t . & {N}_{ti} = {\sum }_{j ∈ {Γ}_{i}} {M}_{tij} ( i ∈ V ) , \\ & {N}_{t + 1 , i} = {\sum }_{j ∈ {Γ}_{i}} {M}_{tji} ( i ∈ V ) , \\ & {M}_{tij} ∈ {ℝ}_{\geq 0} ( i ∈ V , j ∈ {Γ}_{i} ) .\end{matrix} & ( 8 )\end{matrix}$$

is obtained. However, a term

Σ_{iϵV}Σ_{jϵΓ}_{ᵢ}Mₜᵢⱼ [Math. 9]

of the objective function is omitted because the term is a constant due to the constraint. Because it is known that this optimization problem can be solved by using a Sinkhom-Knopp algorithm (P. A. Knight. The Sinkhom-Knopp algorithm: convergence and applications. SIAM Journal on Matrix Analysis and Applications. 2008), the movement probability estimation unit 13 uses this to solve the optimization problem.

Minimization regarding θ can be performed by applying a Lagrange multiplier method, a gradient method, or the like to adjust a parameter θ.

The movement probability estimation unit 13 alternately optimizes M and θ in the procedure as described above until an objective function value converges, and the movement probability estimation unit 13 outputs a finally obtained (learned) AO as the estimated movement probability to the estimated movement probability storage unit 122.

The time-specific area population estimation unit 14 reads the observed time-specific area population data from the observation-time-specific area population storage unit 121, reads the estimated movement probability from the estimated movement probability storage unit 122, and calculates a cost function regarding movement (a cost function between pieces of time-specific population area data (between time-specific population distributions)) based on the time-specific area population data and the movement probability. The time-specific area population estimation unit 14 estimates a population in each area at a time at which no observation is performed, based on the cost function, and outputs an estimation result to the estimation-time-specific area population storage unit 123. An example of a specific processing procedure that is executed by the time-specific area population estimation unit 14 is as follows.

A cost function Cᵢⱼ for moving from the area i to the area j is defined by Cᵢⱼ:=−log \hat{ }θᵢⱼ using the estimated movement probability \hat{ }θ. In this definition, a cost is smaller when the probability of movement from the area i to the area j is higher, and the cost is larger when the movement probability from the area i to the area j is lower. By designing such a cost function, it is possible to perform an estimation so that a large number of moving people are allocated to areas between which the movement probability is estimated to be high. The cost function Cᵢⱼ is estimated from \hat{ }θᵢⱼ, and θᵢⱼ is learned as described above based on the observed time-specific area population data. Thus, it can be said that the cost function Cᵢⱼ is learned based on the observed time-specific area population data.

The time-specific area population estimation unit 14 uses this cost function to estimate the population in each area at a time at which no observation is performed. For example, it is assumed that a population distribution N_{τ} at time τ (t<τ<t+1) between time t and time t+1 is desired to be obtained. A value of τ may be input by the user. A set P={pϵR_{V}|Σ_{iϵV}pᵢ=F, pᵢ≥0 (iϵV)} is considered (R is a set of real numbers), and

an optimization problem

$$\begin{matrix}[ Math . 10 ] & \\ \begin{matrix}{min}_{M} . & {\sum }_{i ∈ V} {\sum }_{j ∈ {Γ}_{i}} ( {M}_{ij} log {M}_{ij} + {C}_{ij} {M}_{ij} ) , \\ s . t . & {ν}_{i} = {\sum }_{j ∈ {Γ}_{i}} {M}_{ij} ( i ∈ V ) , \\ & {μ}_{i} = {\sum }_{j ∈ {Γ}_{i}} {M}_{j i} ( i ∈ V ) , \\ & {M}_{ij} ∈ {ℝ}_{\geq 0} ( i ∈ V , j ∈ {Γ}_{i} ) .\end{matrix} & ( 9 )\end{matrix}$$

is considered for v, μϵP to express an optimal value as f_{C}(ν, μ) that is a function of ν and μ. In this case, an estimated value of N_{τ} is obtained as a solution of the following optimization problem:

$$\begin{matrix}[ Math . 11 ] & \\ {min}_{ν ∈ P} [ ( t + 1 - τ ) \cdot {f}_{C} ( ν , {N}_{t} ) + ( τ - t ) \cdot {f}_{C} ( ν , {N}_{t + 1} ) ] . & ( 10 )\end{matrix}$$

This problem is a problem called Wasserstein Barycenter with Entropic Regularization, for which a method of solving at high speed is known. The time-specific area population estimation unit 14 uses this to solve the problem (M. Cuturi, A. Doucet. Fast Computation of Wasserstein Barycenters. In Proceedings of the 31st International Conference on Machine Learning. 2014).

The time-specific area population estimation unit 14 outputs the obtained N_{τ} to the estimation-time-specific area population storage unit 123.

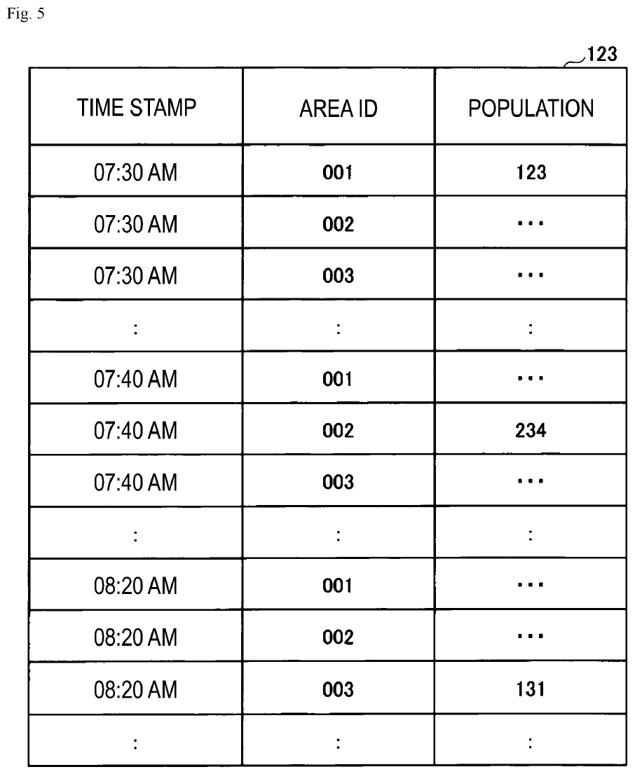

FIG. 5 is a table showing a configuration example of the estimation-time-specific area population storage unit 123. As illustrated in FIG. 5, the estimation-time-specific area population storage unit 123 stores a result of estimating the area-specific population at a time at which no population data is observed (a time corresponding to τ). In FIG. 5, estimation results regarding at least three types of τ are illustrated.

The output unit 15 reads the data stored in the estimation-time-specific area population storage unit 123 and outputs the data. A data output method is not limited to a predetermined method. The data may be displayed on a display apparatus or may be stored in the auxiliary storage device 102 or the like.

As described above, according to the embodiment, a population at a time at which no observation is performed can be estimated, only from the time-specific area population data without requiring external information as a feature quantity or a large amount of learning data for performing learning of a model. Thus, it is possible to efficiently estimate a population at a time at which no observation is performed.

Furthermore, a cost function for automatically measuring a distance between pieces of time-specific area population data is learned from the time-specific area population data that is an input, so that highly accurate estimation can be performed without manually designing the cost function.

Although the embodiments of the present invention have been described above in detail, the present invention is not limited to such specific embodiments, and various modifications and changes can be made within a scope of the gist of the present invention described in the claims.

### REFERENCE SIGNS LIST

10 Time-specific area population estimation apparatus
11 Operation unit
12 Input unit
13 Movement probability estimation unit
14 Time-specific area population estimation unit
15 Output unit
100 Drive apparatus
101 Recording medium
102 Auxiliary storage apparatus
103 Memory apparatus
104 Processor
105 Interface apparatus
121 Observation-time-specific area population storage unit
122 Estimated movement probability storage unit
123 Estimation-time-specific area population storage unit
B Bus

1. A time-specific area population estimation method executed by a computer, the method comprising:
estimating a time-specific interareal movement probability, based on observed time-specific population in an area and a set of candidate areas for a movement from the area in a unit time; and
estimating a population in the area at a time at which no observation is performed by using a cost function learned in the estimating of the time-specific interareal movement probability.

2. The time-specific area population estimation method according to claim 1, wherein, in the estimating the time-specific interareal movement probability, the time-specific interareal movement probability is estimated by using a collective flow diffusion model.

3. The time-specific area population estimation method according to claim 1, wherein the population in the area at the time at which no observation is performed is estimated by computing a Wasserstein Barycenter while using the cost function.

4. A time-specific area population estimation apparatus comprising:
a processor; and
a memory that includes instructions, which when executed, cause the processor to execute the following steps:
estimating a time-specific interareal movement probability, based on observed time-specific population in an area and a set of candidate areas for a movement from the area in a unit time; and
estimating a population in the area at a time at which no observation is performed by using a cost function learned in the estimation of the movement probability.

5. The time-specific area population estimation apparatus according to claim 4, wherein the interareal movement probability is estimated by using a collective flow diffusion model.

6. The time-specific area population estimation apparatus according to claim 4, wherein the population in the area at the time at which no observation is performed is estimated by computing a Wasserstein Barycenter while using the cost function.

7. A non-transitory computer readable storage medium storing a program for causing a computer to execute the time-specific area population estimation method according to claim 1.
